(19) United States
(12) Patent Application Publication
(10) Pub. No.: US 2013/0213581 A1
(43) Pub. Date: Aug. 22, 2013

(54) LABELS

(71) Applicants: Michael Taylor, Wigton (GB); Richard Waning, Wigton (GB); Barry Frizell, Wigton (GB)

(72) Inventors: Michael Taylor, Wigton (GB); Richard Waning, Wigton (GB); Barry Frizell, Wigton (GB)

(73) Assignee: Innovia Films Limited, Wigton, Cumbria (GB)

(21) Appl. No.: 13/817,712

(22) PCT Filed: Sep. 7, 2011
(86) PCT No.: PCT/GB2011/051672

§ 371 Date: Apr. 29, 2013

(30) Foreign Application Priority Data
Sep. 10, 2010 (GB) 1015119.9

(51) Int. Cl. B32B 43/00; G09F 3/10; B29D 7/01; B65D 23/08

(52) U.S. Cl. CPC B32B 43/006; B65D 23/08; G09F 3/10; B29D 7/01
USPC 156/703; 206/459.5; 428/343; 428/40.1; 264/235.8; 526/351

(57) ABSTRACT

The present invention provides a film of an oriented material which exhibits the property of expansion in at least one of its machine and transverse directions at a first temperature and of shrinkage at a second, higher, shrink onset temperature, the film having been annealed after orientation at a temperature above the first temperature and selected with reference to an intended recycling wash-off process to promote expansion of the film at the selected temperature of the wash-off process.

This application is a national stage application of International Patent Application No. PCT/GB2011/051672, filed Sep. 7, 2011, which claims priority to United Kingdom Application No. 1015119.9, filed Sep. 10, 2010. The entirety of all of the aforementioned applications is incorporated herein by reference.

### FIELD

The present invention relates to labels which are easily removable from articles to which they are adhered. More specifically, the present invention provides a film which expands upon exposure to heated fluids. The invention also provides methods of producing such labels and also for applying and removing such labels from articles.

### BACKGROUND

Articles having labels adhered thereto are used in a wide range of industries. In many of these industries, especially the beverage industry, the articles in question may be reused. When such articles, for example beverage bottles, are returned by the consumer, they are cleaned to remove any traces of their previous contents and also commonly, to remove the label adhered thereto.

Numerous automated label removal systems are known to those skilled in the art. Rather than rely on mechanical means to remove the labels by abrasion, peeling or other such techniques, the majority of these systems make use of a heated washing liquid, which is usually caustic, to which the labelled articles are exposed. At elevated temperatures the adhesive bond between the label is weakened and the chemical effect of the cleaning fluid further promotes this weakening of adhesion.

To improve the effectiveness of such systems, attempts have been made to provide labels which facilitate their removal from articles under conventional washing conditions.

For example, in WO2010/026163, a multi-ply label is disclosed that is formed from materials which, when exposed to conventional washing conditions, shrinks by broadly equivalent amounts in the machine and transverse directions. This allows the cleaning fluid to enter the space between the label and the article, forcing the label off.

The labels disclosed in WO2006/076327 and WO2006/106309 are multi-ply structures comprising layers which are intended to curl away from the article upon exposure to conventional washing conditions. The curling of the label lifts it from the bottle, enabling the cleaning fluid to wash the label from the article to which it is adhered.

Similarly, WO2009/043975 discloses a multi-ply label which curls upon exposure to elevated temperatures due to differences in layer thickness or orientation.

WO 2010/1 17774 discloses polymeric adhesive labels and their removal from containers in a washing process. The labels disclosed in this document either do not shrink at all, or do not expand at all.

Other removable labels are described in EP-A-0794523 and in WO 201 0/027507.

While these prior art films do have a positive effect in facilitating their removal from articles to which they are adhered, there are a number of disadvantages associated with their use.

For example, to ensure that the films reliably shrink and/or curl as intended, multilayer structures are required that increase the complexity and cost of label manufacture. Further, such labels tend to have a relatively high density and therefore sink in the cleaning fluid which makes removal of the labels from the cleaning system problematic, especially in systems involving recycling of containers to which labels are adhered (PET containers for example), in which often separation of the label from the container by flotation of the removed label in the wash fluid is effected.

Additionally, once shrunk or curled, labels may form rods of material which are difficult to remove from the washing system. Those rods may also enter the article being cleaned and their removal is problematic. The shrinking or curling of labels may also be problematic as ink printed thereto may become detached and be transferred to other articles via the cleaning fluid.

Films which shrink or curl upon exposure to elevated temperatures are, by definition, heat sensitive. Many techniques used to prepare labels prior to adhesion to articles, such as printing, are performed at elevated temperatures. The label's tendency to shrink or curl makes the performance of such techniques challenging.

An additional disadvantage with prior art labels of the type discussed above is that there is a tendency for the labels to perform (i.e. shrink or curl) only at specific conditions, for example at specific temperatures or in cleaning fluids having a specific caustic content. Accordingly, the rate of label removal may vary depending on the washing system employed, which is undesirable.

Accordingly there remains a need in the art for a label that facilitates its rapid removal in conventional washing systems and which exhibits one or more of the following advantages: the labels have a simplified structure, manufacture of the labels is straightforward, the labels are not excessively costly, the labels have a low density, the labels float in most conventional cleaning fluids, the labels do not form rods following their removal from the articles to which they were adhered, the labels do not shed ink printed thereupon as they are removed from articles to which they are adhered, the labels can be easily worked upon using conventional techniques (such as printing) prior to adhesion to articles, the labels are capable of facilitating their removal across a wide range of operating temperatures, the labels are capable of facilitating their removal when exposed to a broad range of cleaning fluids.

### BRIEF DESCRIPTION OF THE DRAWINGS

FIG. 1 demonstrates the compared of area expansion change of the present sample B to a number of different wash-off temperature.

FIG. 2 shows the results of an investigation of the degree of thermally induced shrinkage of a PET film.

### DETAILED DESCRIPTION

Accordingly, the present invention provides labels which are easily removable from articles to which they are adhered. More specifically, the present invention provides a film which expands upon exposure to heated fluids. This allows labels prepared from the labelstock to be more easily removed from articles to which they are adhered. The invention also provides methods of producing such labels and also for applying and removing such labels from articles.

According to a first aspect of the present invention, there is provided a film of an oriented material which exhibits the property of expansion in at least one of its machine and transverse directions at a first temperature and of shrinkage at a second, higher, shrink onset temperature, the film having been annealed after orientation at a temperature above the first temperature and selected with reference to an intended recycling wash-off process to promote expansion of the film at the selected temperature of the wash-off process.

By “expansion” and “shrinkage” we preferably mean throughout this specification “thermal expansion” and/or “thermal shrinkage”. That is to say, the films of the invention expand on the application of heat at the first temperature, and shrink on the application of heat at the second temperature. Some prior art films may in particular expand in the wash liquor by the absorption of the wash liquid, not by thermal expansion.

Preferably, upon exposure to a wash fluid having a temperature at or greater than the first temperature but beneath the shrink onset temperature of the film, the film expands in at least one direction. Expansion in the wash fluid may be by no more than 15% in any single direction, and/or by an amount such that the area of the film is increased by no more than 15%.

We have discovered that certain types of oriented film which may otherwise be characterized as shrink films (in the sense that, eventually on the application of sufficient amounts of heat to the film, they will shrink back from their original dimensions—in one or both of the machine and transverse directions) will in fact expand over a limited range of temperature, and that such expansion affords a valuable mechanism for removal of the film from a container or other article to which the film has been adhesively labeled.

What has been realized in this connection is that the films used in accordance with this invention will expand in a heated wash fluid at certain temperatures, in particular at temperatures such as are commonly used in labeled container recycling procedures to recover label material, or container material, in a wash-off procedure. Different processes use different temperatures, but wash-off temperatures of from about 40° C. to about 100° C. are typical. At temperatures within this range the films used in this invention exhibit an expansion in one or both of the machine and transverse directions, typically an expansion of not more than about 15% in either direction. At higher temperatures, and as might in any event be expected for an oriented film, the films used in this invention will begin to shrink, and may eventually shrink back to less than their original dimensions before expansion. The temperature at which the films used in this invention begin to shrink will vary depending upon the precise nature of the film in question and its manner of manufacture. We call this temperature the “shrink onset temperature”.

One important feature of this invention in many of its preferred aspects is to provide films for use as labelstock in which the shrink onset temperature is controlled to be above the temperatures typically used in recycling wash-off procedures. By controlling the shrink onset temperature we are able to provide films which reliably expand in a typical wash fluid, thereby affording an excellent mechanism for wash-off removal, as will be explained.

Thus, in one aspect of the invention there is provided a facestock film for labels of an oriented material which exhibits the property of expansion in at least one of its machine and transverse directions at a first temperature and of shrinkage at a second, higher, shrink onset temperature, the film having been annealed after orientation at a temperature above the first temperature.

Preferably the first temperature is from about 40° C. to about 100° C. and the annealing temperature is at least about 10° C., preferably at least about 20° C., more preferably at least about 30° C. and most preferably at least about 40° C. above the first temperature.

In preferred aspects of the invention, the film is annealed after orientation at a temperature beneath the shrink onset temperature in at least one of the machine or transverse directions.

We have therefore found that we control the shrink onset temperature of the film by controlling the annealing temperature after orientation. By annealing the film at a temperature above that of standard recycling wash fluids we can ensure that the film expands in any such wash-off fluid.

Preferably, the annealing temperature is at least about 40° C., more preferably at least about 60° C., still more preferably at least about 80° C. and most preferably at least about 100° C. Even more preferably, annealing or heat set temperatures may be of the order of about 100° C. to about 150° C., more preferably from about 110° C. to about 145° C. and most preferably from about 120° C. to about 140° C.

Filmic labels formed from the films of the invention can conveniently be removed from articles to which they are adhered using conventional washing techniques in which articles are exposed to heated cleaning fluids. Upon exposure to heated fluids, the label expands, forming capillaries or micro-tunnels between the label and the article. Cleaning fluid can then enter those channels to facilitate removal of the label by dewetting the label/glass interface.

An advantage of the film of the present invention is that only a relatively low degree of expansion of the film is required to facilitate removal from an article to which it is adhered. Preferably, the film expands by no more than 15% in any single direction or by no more than 15% of its area.

In especially preferred arrangements, the film expands by no more than about 10%, about 8%, about 6%, about 5%, about 4%, about 3%, about 2%, or even about 1% in any single direction when exposed to the heated cleaning fluid for a duration of two minutes.

In preferred embodiments of the present invention, the area of the film of the above first aspect of the present invention increases by no more than about 15% upon exposure to a fluid having a temperature equal to or greater about 40° C. for 2 minutes. In especially preferred embodiments, the area of the film increases by about 12% or less, about 10% or less, about 8% or less, about 5% or less, about 4% or less, about 3% or less, about 2% or less, about 1.5% or less or even about 1% or less when exposed to a fluid having a temperature equal to or greater than about 40° C. for 2 minutes.

The relatively low degree of expansion, less than about 15% in any single direction, prevents labels made from the film from curling substantially and potentially forming dense rods which are observed when certain prior art labels are removed using conventional washing systems.

Consequently, preferred films in accordance with the invention do not curl substantially in the wash. Preferably by this we mean that the film will not under normal washing conditions curl upon itself in an A to B configuration. Slight curling is acceptable but the film should not fully curl such that an A side of the film comes into contact with a B side of the film, in order for the film to be in accordance with the invention. Curling A to B causes the film to form rods in the washing fluid, which is preferably avoided as these can be difficult to separate from the wash liquor after washing. By slight curling (which is acceptable in accordance with the invention) we preferably mean that the film does not curl in the wash to an extent such any edge of the film curls beyond the perpendicular with respect to the remaining film.

In arrangements where the film expands in at least two directions, the degree of expansion may be the same or different in each direction.

The polymer film material may be any orientable film, but is preferably a polyolefin, polyester or PVC film. Polypropylene films are especially preferred and will be primarily discussed in this specification. Typically such films will be multi-layer films comprising at least one core layer, but monoweb films may also be contemplated. In the event of a multi-layer film, and as will be discussed in greater detail below, additional layers besides the core layer are preferably included in A film according to the present invention. In order to reduce the degree of curling of the label, or to prevent curling altogether, the coefficient of thermal expansion of all layers is preferably broadly similar; significant differences in the coefficient of expansion between layers will likely result in the label curling.

Thus, it will be understood that the labels of the present invention are formed of filmic materials selected such that they expand upon exposure with cleaning fluid at temperatures observed in conventional article washing systems, i.e. at about 40° C. or higher. In specific arrangements of the present invention, the fluid temperature necessary to trigger expansion of the label is as high as about 50° C., about 55° C. or even about 60° C., or higher.

While there is hypothetical no maximum fluid temperature for causing the label of the present invention to expand, temperatures exceeding the boiling point of water are generally less preferable as most conventional article washing systems retain cleaning fluid in the liquid phase. Thus, the preferred upper limits of the range of fluid temperatures which cause the film of the present invention to expand are, for example, about 120° C., about 110° C., about 105° C., about 100° C. or about 95° C.

An advantage of the film of the present invention is that it will exhibit expansion when contacted with a range of heated cleaning fluids. Conventionally used cleaning fluids tend to vary in terms of their sodium hydroxide content. The label of the present invention is preferably suitable for use with cleaning fluids containing about 1 to 4 weight percent of sodium hydroxide. However, some washing systems do not include sodium hydroxide and in fact we have found that many of the labels of the present invention wash off perfectly satisfactorily in water.

Especially preferred materials from which the film is produced are those having a high degree of stiffness. This is because, once capillaries or micro-tunnels have been formed, allowing ingress of cleaning fluid into the interface between the label and the article and a corner of the label becomes detached from the article, a phenomenon known as the ‘flapping sail’ effect is observed. More specifically, as a result of the stiffness of the film and the current of the cleaning fluid flowing past the detached corner of the label, that detached corner will flap back and forth and this will facilitate the removal of the label from the article.

Preferably the filmic material of the labelstock exhibits a Gurley stiffness of from 10 to 35, more preferably from 11 to 34, still more preferably from 12 to 32, and most preferably from 13 to 30 in one or both of the machine and/or transverse directions.

The oriented film may be uniaxially or biaxially oriented, and such orientation may be simultaneous or sequential. Biaxially orientated films may be prepared as balanced films using substantially equal machine direction and transverse direction stretch ratios, or can be unbalanced, where the film is significantly more orientated in one direction (MD or TD). Sequential stretching can be used, in which heated rollers effect stretching of the film in the machine direction and a stenter oven is thereafter used to effect stretching in the transverse direction. Alternatively, simultaneous stretching, for example, using the so-called bubble process, or simultaneous draw stenter stretching may be used.

Especially preferred materials for preparing the core layer include biaxially oriented polypropylene homopolymer optionally blended with a random copolymer of propylene and ethylene as these materials allow the degree of expansion of the core layer to be controlled, while exhibiting a good degree of stiffness.

In preferred arrangements of the present invention, the film includes an adhesive receptive layer. This may be immediately adjacent to the polyolefin layer, or may be spaced therefrom by one or more intermediate layers.

It will be appreciated that the adhesive receptor layer and any other additional layers which are employed in A film according to the present invention will be tightly bound to each other and the polymeric core layer to prevent delamination of the label during the course of its expansion.

It is also preferred that the film of the present invention has a density less than that of water to ensure that labels formed therefrom float in the cleaning fluids conventionally used in washing systems.

In preferred embodiments of the present invention, the film is transparent and capable of being applied to articles to provide a ‘no-label’ look.

The adhesive receptive layer may be formed of any material which is capable of being strongly bound both to the remainder of the film and also to the adhesive which is to be applied to the film. In preferred arrangements of the present invention, the adhesive receptive layer is polyolefinic.

A film according to the present invention preferably includes an ink receptive layer which may comprise, for example, polyolefinic material, polyester material and/or a copolymer of styrene and butadiene.

The ink receptive layer is preferably directly printable, either inherently or with the aid of a suitable treatment. To improve the receptivity of the film surface to printing inks, and/or to improve strength of adhesion between the film and the adhesive, the surface of the receptive layer on which adhesive or ink is to be applied (i.e. the outer or inner surface of the film) may be surface treated, e.g. by dielectric barrier discharge plasma or corona at low-pressure or oxygen excluded plasma, Chemical corona, CVD (Chemical Vapour Deposition), PECVD (Plasma Enhanced Chemical Vapour Deposition), Polarised Flame Treatment, PVD (Physical Vapour Deposition), Vapour deposition and Electron Beam, Spluttering, and combinations thereof.

The film of the present invention also preferably comprises an adhesive layer, which may be a pressure-sensitive adhesive layer. Examples of materials from which the adhesive layer may be formed include the hot melt adhesives sold by Henkel under the Technomelt trade mark.

The film of the invention may further comprise a release coated liner in contact with and releasably joined to the adhesive layer. However, linerless labels are also specifically contemplated in this invention.

Further examples of additional layers that may be present in the film of the present invention include, for example, lamination layers, printable layers, UV barrier layers, oxygen permeability or barrier layers, water vapour permeability or barrier layers and the like.

The additional layers which may be included in the film of the present invention may be formed by coextrusion with the core layer, by the subsequent application of one of more coats onto the surface of the already formed core layer, by extrusion coating, or by a combination thereof.

The film may comprise, in any layer of the film when a multi-layer film is provided—in this case in its core layer and/or in one or more of its additional layers—functional materials for other purposes in relation to the functional or aesthetic characteristics of the film. Suitable functional materials may be selected from one or more of the following, mixtures thereof and/or combinations thereof: UV absorbers, dyes; pigments, colorants, metallised and/or pseudo-metallised coatings; lubricants, anti-static agents (cationic, anionic and/or non-ionic, e.g. poly-(oxyethylene) sorbitan monooleate), anti-oxidants (e.g. phosphorous acid, tris (2,4-di-tert-butyl phenyl)ester), surface-active agents, stiffening aids, slip aids (for example hot slips aids or cold slip aids which improve the ability of a film to slide satisfactorily across surfaces at about room temperature, e.g. micro-crystalline wax; gloss improvers, prodegradants, barrier coatings to alter the gas and/or moisture permeability properties of the film (such as polyvinylidene halides, e.g. PVdC); anti-blocking aids (for example microcrystalline wax, e.g. with an average particle size from about 0.1 to about 0.6 μm); tack reducing additives (e.g. fumed silica, silica, silicone gum); particulate materials (e.g. talc); additives to increase COF (e.g. silicon carbide); additives to improve ink adhesion and/or printability, additives to increase stiffness (e.g. hydrocarbon resin); additives to increase shrinkage (e.g. hard resin).

Some or all of the additives listed above may be added together as a composition to coat the film of the present invention and/or form a new layer which may itself be coated and/or may form the outer or surface layer of the labelstock. Alternatively, some or all of the preceding additives may be added separately and/or incorporated directly into the bulk of the core layer optionally during film formation (e.g. as part of the original polymer composition), and thus they may or may not form layers or coatings as such.

Films of the invention can also be made by the laminating of two co-extruded films. Application of one or more additional layers onto the core layer may conveniently be effected by any of the laminating or coating techniques conventionally employed in the production of composite multi-layer films.

Preferably, one or more additional layers are applied to the polyolefin core by a co-extrusion technique in which the polymeric components of the core and the additional layers are co-extruded into intimate contact while each is still molten. Preferably the co-extrusion is effected from a multichannel annular die so designed that the molten polymeric components constituting individual layers of the film merge at their boundaries within the die to form a single composite structure which is then extruded from a common die orifice in the form of a tubular extrudate. It will be appreciated that any other shape of suitable die could also be used such as flat die.

The film can be made by any process known in the art, including, but not limited to, cast sheet, cast film, or blown film.

The films used in accordance with the present invention can be of a variety of thicknesses according to the application requirements. For example they can be from about 10 to about 240 μm thick, preferably from about 20 to 90 μm thick, and most preferably from about 30 to about 70 μm thick.

According to a further aspect of the present invention, there is provided a labelstock comprising the film of the invention with or without an adhesive layer and a release liner. The invention also concerns labels die cut from such a labelstock, and articles to which such labels have been applied.

According to an additional aspect of the present invention, there is provided a method for applying a label to an article comprising the steps of:

a) preparing a label for adhesion to an article, said label being formed from the film of the above first aspect of the present invention, and

b) contacting said label with said article for a time and pressure sufficient to securely adhere the label to the article.

Specific examples of articles to which the labels of the present invention may be adhered include bottles, jars, or other articles formed of glass or plastics material, tins, cans, or other articles formed of metal.

According to an additional aspect of the present invention, there is provided a method for producing a film comprising orientating a filmic material in one or both of its machine and transverse directions and annealing the oriented film at a temperature selected with reference to an intended recycling wash-off process to provide a film which exhibits the property of expansion in at least one of its machine and transverse directions at the intended temperature of the wash-off process and of shrinkage at a second, higher, shrink onset temperature, the annealing temperature being above the intended recycling wash-off process temperature.

The invention further provided a process for removing labels from labelled articles, comprising the steps of:
a. providing a labelled article as herein described, or an article labelled with a label prepared by the aforesaid method;
b. placing the labelled articles in a wash fluid;
c. heating the wash fluid to the intended or selected wash-off temperature; and
d. removing the label from the article.

There are numerous article washing systems known to those skilled in the art. A film according to the present invention advantageously facilitates rapid removal of labels formed from that labelstock from articles to which they are applied. Optimal results are observed when the temperature of the washing fluid ranges from about 40° C., about 50° C., about 55° C. or about 60° C. to about 95° C., about 100° C., about 105° C., about 110° C. or about 120° C.

The invention is further illustrated by reference to the following examples, which are by way of illustration only, and are not limiting to the scope of the invention described herein.

### Example 1

A three layer polymeric tube was formed by co-extruding a core layer of a polypropylene homopolymer, with terpolymer skin layers. The tube was cooled and subsequently reheated before being blown to produce a three layer biaxially oriented film tube. The film was then nipped and laminated to itself (laminating layer to laminating layer constituting one internal layer) spliced to form a laminated film with five layers to provide a 50 μm thickness laminate film. The Film was annealed under the conditions set out in the table below.

The Shrink Onset temperature is defined at the temperature that the film transitions from having a net expansion to a net shrinkage, a positive dimensional change is an expansion whereas negative dimensional change is shrinkage.

| | Annealing | MD Shrink Onset | TD Shrink Onset |
|---|---|---|---|
| | Temperature | Temperature | Temperature |
| | (° C.) | (° C.) | (° C.) |
| Sample A | 102-116 | 63.6 | >100 |
| Sample B | 110-125 | 83.3 | >100 |
| Sample C | 115-130 | 95.6 | >100 |

| | 80° C. | 80° C. | 80° C. Area |
|---|---|---|---|
| | Dimensional | Dimensional | Dimensional |
| | Change MD (%) | Change TD (%) | Change (%) |
| Sample A | −0.01 | 0.82 | 0.81 |
| Sample B | 0.09 | 1.06 | 1.16 |
| Sample C | 0.25 | 1.12 | 1.36 |

Samples A, B and C are die-cut to form labels, which are adhered to glass bottles. The bottles are stored for 1 week and 5 weeks and then washed in accordance with FINAT method FTM26. The time taken for the labels to be removed is recorded and provided below:

Label

| | Wash-off time 1 | Wash-off time 5 |
|---|---|---|
| Sample | week after labelling | weeks after labelling |
| A | <2 mins | <1.5 mins |
| B | <2 mins | <1.5 mins |
| C | <2 mins | <1.5 mins |

### Example 2

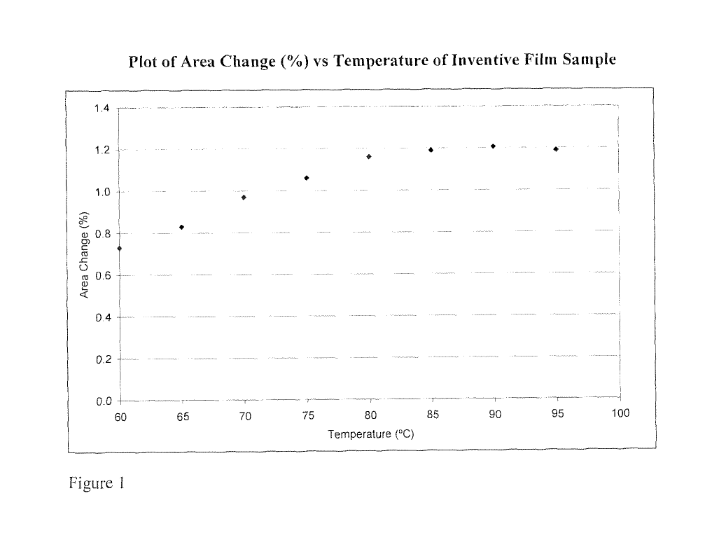

The area expansion change of Sample B was compared at a number of different wash-off temperatures, and the results shown in FIG. 1.

### Example 3

### Comparative

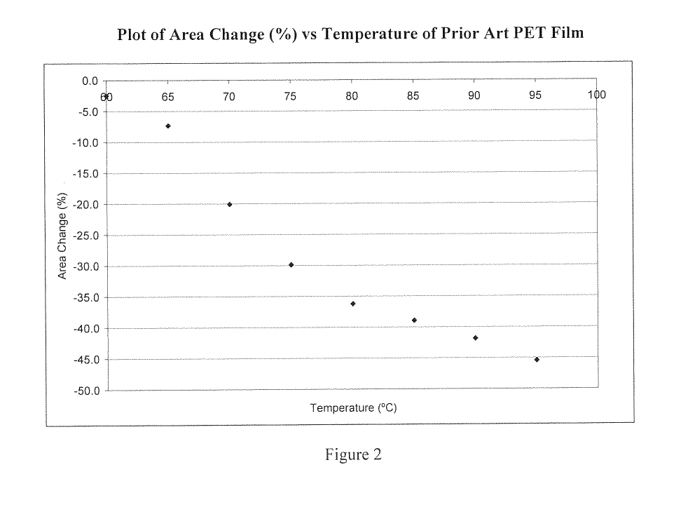

In WO2010/026163, the results of an investigation into the degree of thermally induced shrinkage of a PET film were provided. These results have been plotted onto a chart shown in FIG. 2.

1. A film of an oriented material which exhibits the property of expansion in at least one of its machine and transverse directions at a first temperature and of shrinkage at a second, higher, shrink onset temperature, the film having been annealed after orientation at a temperature above the first temperature and selected with reference to an intended recycling wash-off process to promote expansion of the film at the selected temperature of the wash-off process.

2. The film of claim 1, which upon exposure to a wash fluid having a temperature at or greater than the first temperature but beneath the shrink onset temperature of the film, the film expands in at least one direction.

3. The film of claim 2, wherein the expansion in the wash fluid is by:
a. no more than 15% in any single direction, or
b. an amount such that the area of the film is increased by no more than 15%.

4. The film of claim 3, wherein the expansion is by about 5% or less in any single direction.

5. The film of claim 4, wherein the expansion is by about 2% or less in any single direction.

6. The film of claim 3, wherein the area expansion is 10% or less.

7. The film of claim 6, wherein the area expansion is 5% or less.

8. The film of claim 2, wherein the film does not curl substantially in the wash.

9. The film of claim 2, wherein the first temperature is the minimum temperature of the wash fluid required to cause the film to expand.

10. The film of claim 2, wherein the first temperature is 40° C. or above or 60° C. or above.

11. A labelstock, comprising the film of claim 1.

12. The labelstock of claim 11, further comprising, an adhesive layer and, optionally, a liner.

13. A label severed from the labelstock of claim 11.

14. An article having the label of claim 13 affixed thereto.

15. A method for producing a film, comprising:
orientating a filmic material in one or both of its machine and transverse directions; and
annealing the oriented film at a temperature selected with reference to an intended recycling wash-off process to provide a film which exhibits the property of expansion in at least one of its machine and transverse directions at the intended temperature of the wash-off process and of shrinkage at a second, higher, shrink onset temperature, the annealing temperature being above the intended recycling wash-off process temperature.

16. A process for removing labels from labelled articles, comprising the steps of:
a. providing the article of claim 14;
b. placing the labelled articles in a wash fluid;
c. heating the wash fluid to the intended or selected wash-off temperature; and
d. removing the label from the article.

17. A process for removing labels from labelled articles, comprising the steps of:
a. providing an article labelled with a label prepared by the method of claim 15;
b. placing the labelled articles in a wash fluid;
c. heating the wash fluid to the intended or selected wash-off temperature; and
d. removing the label from the article.

18. A label severed from the labelstock of claim 12.

19. The film of claim 4, wherein the area expansion is 10% or less.

20. The film of claim 5, wherein the area expansion is 10% or less.
